(19) United States
(12) Patent Application Publication
(10) Pub. No.: US 2018/0165756 A1
(43) Pub. Date: Jun. 14, 2018

(54) BIDDING SYSTEM AND METHOD CAPABLE OF PROVIDING MOTIVATION FOR BIDDING

(71) Applicant: Yanyan Cheng, Chicago, IL (US)

(72) Inventor: Yanyan Cheng, Chicago, IL (US)

(21) Appl. No.: 15/375,125

(22) Filed: Dec. 11, 2016

(51) Int. Cl. G06Q 30/08

(52) U.S. Cl. CPC G06Q 30/08; G06Q 50/18

(57) ABSTRACT

This invention concerns a bidding system and method capable of providing motivation for bidding, comprising posting an item for bidding by a posting party; establishing a bidding period by said posting party; establishing a bidding ceiling by said posting party, said bidding ceiling having a group of parameters; starting said bidding period; gathering a bid from a bidding party within said bidding period; processing said bid according to a first pre-determined rules to generate a best bid; repeating above two steps within said bidding period; ending said bidding period; and establishing a contract for said item according to a second per-determined rules.

### BACKGROUND OF THE INVENTION

### Field of the Invention

The present invention relates to a bidding system and method. More specifically, my invention is primarily relates to a bidding system and method capable of providing motivation for bidding. In all the bidding system, an item will be provided to a group of audience. In a regular auction, a bottom price will be provided by seller. Buyers in the audience can submit bids above such bottom price, and the Buyer with the highest price is able to purchase such item, if reserve set by seller is met. In a reserve auction, a ceiling price will be provided by buyer. Sellers in the audience can submit bids below such ceiling price, and the Seller with the lowest price is able to purchase such item. It is a very big problem to set the right ceiling price in a reverse auction system. If the ceiling price is set too high, the buyer might have to purchase item at an unnecessary high price, if the auction is not dynamic enough. If the ceiling price is set too low, there might not be enough attraction to the audience to even submit the bid. The present invention is primarily related to the reverse auction, although it can be applied in regular auction as well. If the ceiling price of the reverse auction is replaced by the bottom price of the regular auction, the present invention can be applied to the regular auction as well. By using this invention, a bidder in a regular auction is able to bid an item at a price blew the bottom price set by the seller. Upon completion of the auction, if the price from buyer is lower than the bottom price set by the seller, the seller can be presented a conditional contract to sell of the item at buyer's offer price. The seller has the choice to either accept the conditional contract to sell the item at below the price set by seller, or reject the conditional contract at no risk at all. In a reverse auction system, the current invention provides sellers with motivation to make bid to sell product to the buyer, even though the willing-to-sell price from the seller is above the ceiling price set by the buyer. The current invention enables buyer to set ceiling price easily, and is able to get market feedback even after the ceiling price is posted to the audience. The current invention enables seller to be able to submit a bid for selling the demanded items even though seller's willing-to-sell price is higher than the ceiling price set by buyer. The current invention also enables the auction to be more dynamic because multiple sellers in the audience can compete with each other to bid down the prices, even though the final price is able the ceiling price set by the buyer. The current invention takes advantage of a seller's wish to sell at a price that is higher than the ceiling price set by buyer, and buyer's wish to buy at a price that is higher than the ceiling price but is the lowest possible price among all willing-to-sell sellers.

### Description of the Prior Art

Auction or reverse auction bidding has been widely adopted by today's market to transfer of various products and services from providers to purchasers. In all the bidding system, a bench mark price is set by either seller or buyer, with bidding rules that the bid can only be either above or below the bench mark price.

U.S. Pat. No. 5,794,207 issued to Walker et al. in 1998 discloses a method and apparatus for a cryptographically assisted commercial network system designed to facilitate buyer-driven conditional purchase offers. The invention is a method and apparatus for effectuating bilateral buyer-driven commerce. The invention allows prospective buyers of goods and services to communicate a binding purchase offer globally to potential sellers, for sellers conveniently to search for relevant buyer purchase offers, and for sellers potentially to bind a buyer to a contract based on the buyer's purchase offer. In a preferred embodiment, the apparatus of the invention includes a controller which receives binding purchase offers from prospective buyers. The controller makes purchase offers available globally to potential sellers. Potential sellers then have the option to accept a purchase offer and thus bind the corresponding buyer to a contract. The method and apparatus of the invention have applications on the Internet as well as conventional communications systems such as voice telephone.

U.S. Pat. No. 6,199,050 issued to Alaia et al. in 2001 discloses a method and system for conducting electronic auctions. A dynamic lot closing extension feature avoids collisions in closing times of multiple lots by dynamically extending the closing time of a subsequent lot if a preceding lot's closing time is extended to be too close to the subsequent lot's then-currently scheduled closing time. Scheduled closing times can be extended with a flexible overtime feature, in which the properties of the event triggering the extension and the duration of the overtime period(s) can be tailored to a particular auction, particular lots of products within an auction, and to the particular time within an action process. The bidding status of a lot can be set to a “pending” status after the nominal closing time for submission of bids to allow bidders to alert the auction coordinator of technical problems in submission of bids. This allows the possibility for a lot to be return to open status for further bidding b all bidders. The auction may be paused by the auction coordinator to correct technical, market and miscellaneous problems that may raise during the course of an action. Individual bid ceilings can be set for each bidder so that they are required to bid lower than certain thresholds determined in advance of the auction. Failsafe error detection is performed to prevent erroneous bids from entering the auction. The auction coordinator has the ability to override any erroneous bids that are entered to prevent prejudice to the auction.

U.S. Pat. No. 6,269,343 issued to Pallakoff in 2001 discloses an on-line marketing system and method. The invention provides a method and system that allows sellers to communicate conditional offers to potential buyers. The conditions include prices that depend on the aggregate amount of goods or services that buyers collectively agree to purchase by a given time and date. The invention facilitates “demand aggregation,” that is, aggregating demand by potential buyers (who may or may not know each other), for products offered by sellers. This invention allows sellers conveniently to offer “Demand-Based Pricing,” that is, prices which go down as the volume of units sold in a given offer goes up. A seller can therefore offer volume discounts to buyers acting as a group, even when the buyers may not have any formal relationship with one another.

U.S. Pat. No. 7,620,619 issued to Walker et al. in 2009 discloses a conditional purchase offer management system. A conditional purchase offer (CPO) management system is disclosed for receiving CPOs from one or more customers, such as airline passengers, and for evaluating the received CPOs against a number of CPO rules defined by a plurality of sellers, such as airlines, to determine whether any seller is willing to accept a given CPO. A CPO is a binding offer containing one or more conditions submitted by a customer for purchase of an item, such as airline travel, at a customer-defined price. A CPO rule is a set of restrictions defined by a given seller, such as an airline, to define a combination of restrictions for which the seller is willing to accept a predefined price. The CPO rules may be securely stored by one or more servers. The CPO management system permits a seller to correct for forecasting errors, if necessary, or other competitive forces which have produced excess capacity, by providing inventory for sale to CPO customers

U.S. Pat. No. 8,589,249 issued to Campbell in 2013 discloses an automated bid proxy for online auctions transmits user-initiated bids to an online auction facility using dynamically adjusted hid times that vary from the user-specified or auction-specified bid times. This dynamic adjustment may advantageously distribute large bid loads over time interval in order to reduce the peak load that is actually experienced by the automate bid proxy at time of a high bid volume.

U.S. Pat. No. 9,129,312 issued to Scholl et al. in 2015 discloses a facility for bidding on a pending advertising opportunity. The facility receives at an advertiser a notification from a publisher. The notification contains keywords relating to a content request received by the publisher, and is sent by the publisher between its receipt of the content request and its dispatch of a content response responsive to the content request. In response to receiving the notification, the facility sends to the publisher a dynamic bid. The dynamic id specifies an advertising message and a bid amount that the advertiser is willing to pay to present the advertising message in connection with a content response responsive to the content request produced by the publisher.

U.S. Patent Application Publication No. US 2012/0296761 A1 by Mayer in 2012 discloses a system and method for group bidding according to an overall group bid. The publication discloses a system and method for group bidding, in which the supplier accepts or reject the bids of the group as a group according to at least the overall group bid of the group, without being allowed to select or remove individual user bids, and optionally based upon one or more other characteristics of the group. A supplier is not permitted to remove one or more users from the group but instead accepts or rejects the bid of the group according to the overall group bid, such as a group average bid. The supplier is optionally permitted to make a counter offer with regard to the overall group bid, which has the effect of increasing reimbursement to the supplier, for example by increasing the overall group bid, such as for example by increasing the group average bid. This invention is only applicable for a group bidding of one single product, rather than a group of different products. The group average bid does not work for products with different pricing. Furthermore, the seller would not be able to protect its price bottom line by accepting group bidding of such method disclosed herein. Even the publication itself discloses that statistical bid analysis module may perform statistical analysis with regard to previously accepted group bids to predict the likelihood of a group average bid being accepted according to historical trends of such acceptance.

The seller is only interested in selling its products at a price that is acceptable to seller. The buyer however might want to purchase such product at a price lower than the price the seller is willing to sell. In that case, there will be no deal between the buyer and the seller. However, in the case that the seller's willing to sell price is lower than the buyer's willing to buyer price, the buyer is not necessary willing to provide its willing to buy price to the seller. Therefore, in most of the cases, in a reverse auction system, it is very hard for buyer to set its actual willing to buy price as its ceiling price. Instead, in most of cases, a buyer will set its ceiling price to much a much higher price than its actual willing to buy price. This defect leads to a lot of failure in the reverse auction system.

What is needed then is a system and method to help minimize the impact of the ceiling price set buy the buyer on the willingness to bid by the seller.

Accordingly, it is a principal objective of my invention to provide a bidding system and method capable of providing motivation for bidding by the seller.

It is a further objective of my invention to provide a bidding system and method that is easy for buyer to set its ceiling price in a reverse auction system.

It is a still further objective of my invention to provide a bidding system and method that is capable of allowing the seller to make its bid for a price that is higher than the purchase price set by the buyer to form a condition contract.

Other objects of my invention, as well as particular features, elements, and advantages thereof, will be elucidated in, or apparent from, the following description and the accompanying drawing figures.

### SUMMARY OF THE INVENTION

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

According to my present invention, I have provided a bidding method capable of providing motivation for bidding. Said bidding method comprises posting an item for bidding by a posting party; establishing a bidding period by said posting party; establishing a bidding ceiling by said posting party, said bidding ceiling having a group of parameters; starting said bidding period; gathering a bid from a bidding party within said bidding period; processing said bid according to a first pre-determined rules to generate a best bid; repeating above two steps within said bidding period; ending said bidding period; and establishing a contract for said item according to a second per-determined rules.

Said item for bidding can be one single item, or a group of items. Said bidding period can be modified. Said bidding party can be a single bidder or a group of bidders. Said first pre-determined rules generate said best bid according to said group of parameters. Said second pre-determined rules include a first rule to set said contract to be a binding contract, if said best bid is less than or equal to said bidding ceiling defined by said group of parameters, and a second rule to set said contract to be a conditional contract, if said best bid is higher than said bidding ceiling defined by said group of parameters, said conditional contract becoming a binding contract if said posting party accepting said best bid within a certain period of time defined by said second pre-determined rules, said second pre-determined rules preventing said bidding party from withdrawing said best bid within said certain period of time.

According to my present invention, I have also provided a bidding system capable of providing motivation for bidding. Said bidding system comprises means for posting an item for bidding by a posting party; means for establishing a bidding period by said posting party; means for establishing a bidding ceiling by said posting party, said bidding ceiling having a group of parameters; means for starting said bidding period; means for gathering a bid from a bidding party within said bidding period; means for processing said bid according to a first pre-determined rules to generate a best bid; means for repeating above two steps within said bidding period; means for ending said bidding period; and means for establishing a contract for said item according to a second per-determined rules.

According to my present invention, I have also provided a bidding computer program capable of providing motivation for bidding. Said bidding computer program comprises computer program means for posting an item for bidding by a posting party; computer program means for establishing a bidding period by said posting party; computer program means for establishing a bidding ceiling by said posting party, said bidding ceiling having a group of parameters; computer program means for starting said bidding period; computer program means for gathering a bid from a bidding party within said bidding period; computer program means for processing said bid according to a first pre-determined rules to generate a best bid; computer program means for repeating above two steps within said bidding period; computer program means for ending said bidding period; and computer program means for establishing a contract for said item according to a second per-determined rules.

The present invention can also be used to in a reverse auction system, where buyer sets a price for a group of sellers to compete with each other to provide the lowest possible price to meet buyer's demand.

Other technical advantages will be readily apparent to one skilled in the art from the following figures, descriptions and claims. Moreover, while specific advantages have been enumerated above, various embodiments may include all, some or one of the enumerated advantages.

Embodiments may be implemented as a computer, a computer process, a computing system or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instruction for executing a computer process.

### DESCRIPTION OF THE DRAWINGS

Other features of my invention will become more evident from a consideration of the following detailed description of my patent drawings, as follows:

FIG. 1 is a structure demonstration drawing of the preferred embodiment of current invention;

FIG. 2 is a flow chart for the preferred embodiment of the bidding method of current invention.

### DETAILED DESCRIPTION OF THE PREFERRED EMBODIMENT

Various embodiments are described more fully below with reference to the accompanying drawings, which form a part hereof, and which show specific embodiments for practicing the embodiments described herein. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments may be practiced as methods, systems, or devices. Accordingly, embodiments may take the form of a hardware implementation, an entirely software implementation or an implementation combing software and hardware aspects.

Referring now to the drawings, my invention concerns a bidding method and system capable of providing motivation for bidding.

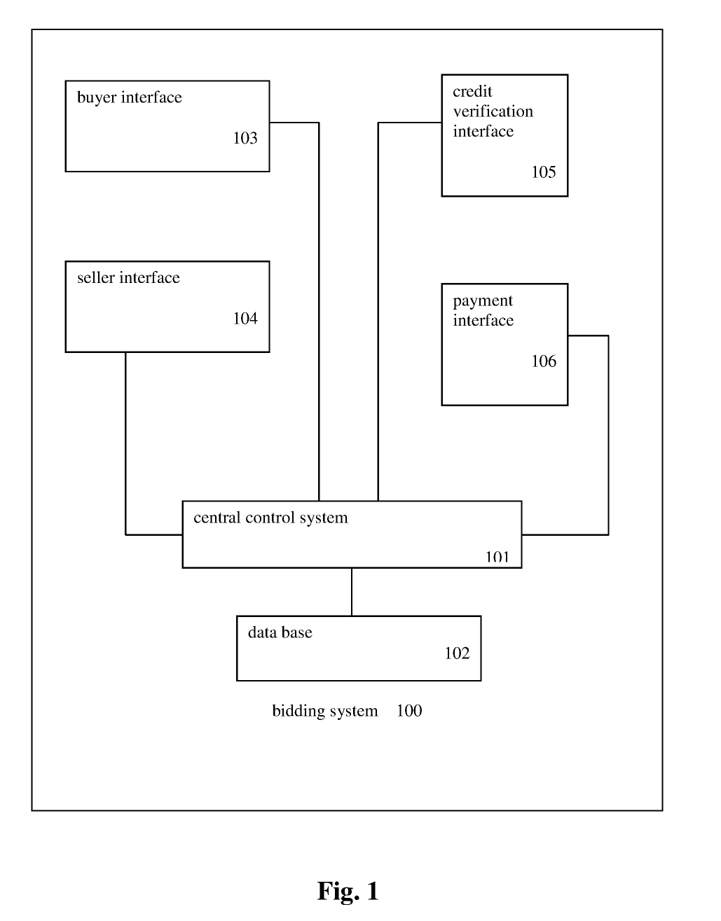

Referring now to FIG. 1, which is a structure demonstration drawing of a preferred embodiment of current invention of bidding system 100. Said bidding system 100 comprises a central control system 101, said central control system 101 capable of receiving and processing the following steps, including posting an item for bidding by a posting party; establishing a bidding period by said posting party; establishing a bidding ceiling by said posting party, said bidding ceiling having a group of parameters; starting said bidding period; gathering a bid from a bidding party within said bidding period; processing said bid according to a first pre-determined rules to generate a best bid; repeating above two steps within said bidding period; ending said bidding period; and establishing a contract for said item according to a second per-determined rules. Said first pre-determined rules generate said best bid according to said group of parameters. Said second pre-determined rules include a first rule to set said contract to be a binding contract, if said best bid is less than or equal to said bidding ceiling defined by said group of parameters, and a second rule to set said contract to be a conditional contract, if said best bid is higher than said bidding ceiling defined by said group of parameters, said conditional contract becoming a binding contract if said posting party accepting said best bid within a certain period of time defined by said second pre-determined rules, said second pre-determined rules preventing said bidding party from withdrawing said best bid within said certain period of time.

Said bidding system 100 also comprises a buyer interface 103, said buyer interface 103 being controlled by said central control system 101, and through which said one buyer or said multiple buyers being able to post item or items for bidding, as well as receive the final bid from the sellers, and contract information associated therewith.

Said bidding system 100 also comprises a seller interface 104, said seller interface 104 being controlled by said central control system 101, and through which said one seller or said multiple sellers being able to make bids to posted item, as well as receive the contract information associated therewith.

Said bidding system 100 also comprises a credit verification interface 105, said credit verification interface 105 being accessed by said central control system 101, said one buyer or said multiple buyers, and said one seller or said multiple sellers.

Said bidding system 100 also comprises a payment interface 106, said payment interface 106 being accessed by said central control system 101, said one buyer or said multiple buyers, and said one seller or said multiple sellers.

Said bidding system 100 also comprises a data base 102, said data base can be one single data base or a group of individual data bases. Such data base 102 collects and contains all the information related to the item posted and bids made.

Said central control system 101 is capable of gathering and processing said bid according to per-determined rules within a pre-set bidding period.

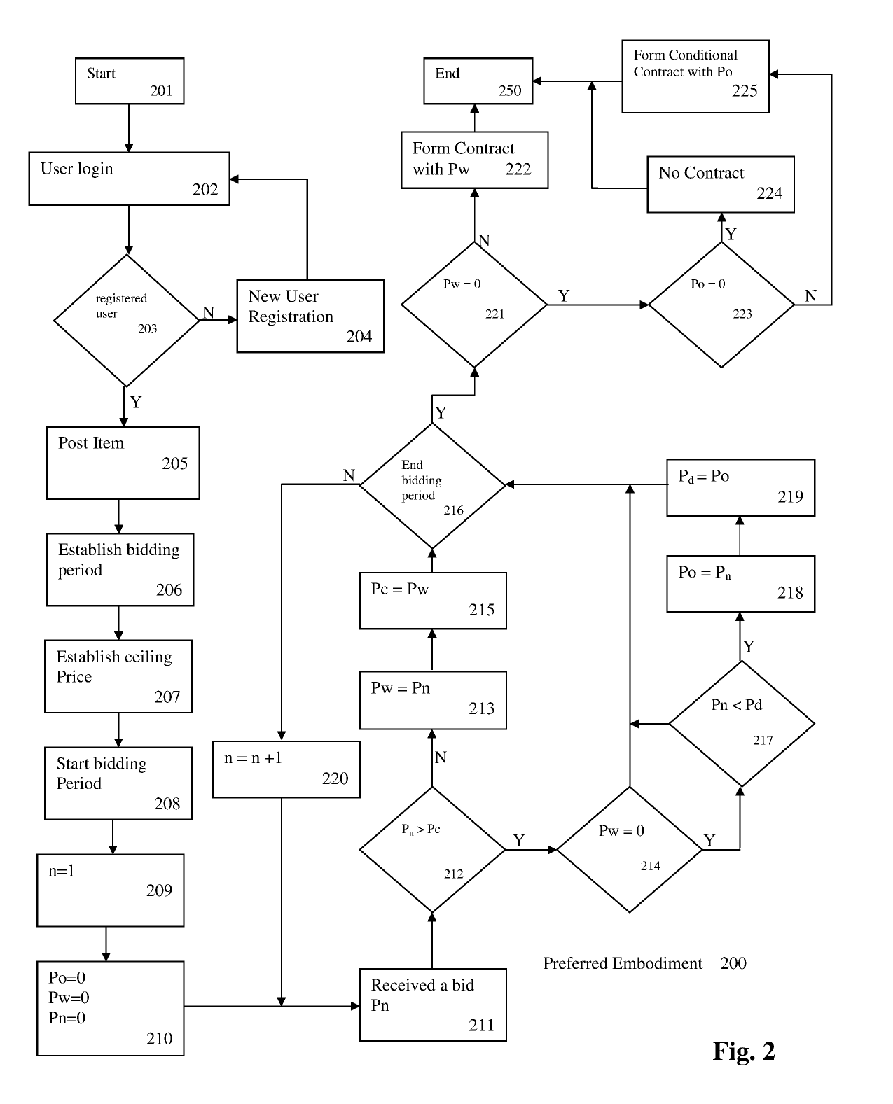

Referring now to FIG. 2, which is a flow chart for the preferred embodiment of the bidding method of current invention 200. Said bidding method is processed by said central control system 101. Said bidding method 200 is capable of providing motivation for bidding.

Said group bidding method starts at step 201 and proceed to step 202. At step 202, said method enables various users, including both buyers and sellers, to login and then proceed to step 203. At step 203, said method verifies whether the user has been registered and has access authorization. If the answer at step 203 is no, the method proceeds to step 204. At step 204, the method enables user to register, and proceed back to step 202. If the answer at step 203 is yes, the method proceeds to step 205. At step 205, the method allows user to post item for bidding, and proceed to step 206. The user can post one single item or a group of items. At step 206, the method establishes a bidding period for the seller to be able to bid for selling the item posted, and proceed to step 207. At step 207, said method establishes a Ceiling Price Pc, and proceed to step 208. At step 208, the method starts the bidding period, and proceeds to step 209. At step 209, the method sets n=1, and proceeds to step 210. At step 210, the method sets Po=0, Pw=0, Pd=0, and proceeds to step 211. At step 211, the method receives a bid Pn, and proceeds to step 212. At step 212, the method decides whether Pn>Pc. If the answer at step 212 is No, the method proceeds to step 213; if the answer at step 212 is Yes, the method proceeds to step 214. At step 213, the method sets Pw=Pn, and proceed to step 215. At step 215, the method sets Pc=Pw, and proceeds to step 216. At step 214, the method decides whether Pw=0. If the answer at step 214 is No, the method proceeds to step 216. If the answer at step 214 is Yes, the method proceeds to step 217. At step 217, the method decides whether Pn<Pd. If the answer at step 217 is No, the method proceeds to step 216. If the answer at step 217 is Yes, the method proceeds to step 218. At step 218, the method sets Po=Pn, and proceeds to step 219. At step 219, the method sets Pd=Po, and proceeds to step 216. At step 216, the method decides whether to end bidding period. If the answer at step 216 is No, the method proceeds to step 220. At step 220, the method sets n=n+1, and proceeds to step 211. If the answer at step 216 is Yes, the method proceeds to step 221. At step 221, the method decides whether Pw=0. If the answer at step 221 is No, the method proceeds to step 222. At step 222, the method forms a bidding contract for the item with price between buyer and seller at Pw, and proceeds to step 250. If the answer at step 221 is Yes, the method proceeds to 223. At step 223, the method decides whether Po=0. If the answer at step 223 is Yes, the method proceeds to step 224. At step 224, the method informs the buyer that no contract for the item, and proceed to step 250. If the answer at step 223 is No, the method proceeds to 225. At step 225, the method forms a conditional contract for the item with offer to sell price at Po, such conditional contract can be ratified by buyer to form a binding contract, and proceeds to step 250. At step 250, the method ends.

As various possible embodiments may be made in the above invention for use for different purposes and as various changes might be made in the embodiments and methods above set forth, it is understood that all of the above matters here set forth or shown in the accompanying drawings are to be interpreted as illustrative and not in a limiting sense.

It is to be understood that the invention is not limited in its embodiments disclosed in the preceding description or illustration in the drawings. The invention is capable of other embodiments and of being practiced and carried out in various ways. It is to be understood that the phraseology and terminology employed herein are for the purpose of descriptions and illustrations, and should not b regarded as limitations.

The above description will enable any person skilled in the art to make and use this invention. It also sets forth the best embodiments for carrying out this invention. There are numerous variations and modifications thereof that will also remain readily apparent to others skilled in the art, now that the general principles of the present invention have been disclosed. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

I claim:

1. A bidding method capable of providing motivation for bidding, said bidding method comprising:
posting an item for bidding by a posting party;
establishing a bidding period by said posting party;
establishing a bidding ceiling by said posting party, said bidding ceiling having a group of parameters;
starting said bidding period;
gathering a bid from a bidding party within said bidding period;
processing said bid according to a first pre-determined rules to generate a best bid;
repeating above two steps within said bidding period;
ending said bidding period; and
establishing a contract for said item according to a second per-determined rules.

2. The bidding method capable of providing motivation for bidding in claim 1, wherein said item for bidding can be one single item, or a group of items.

3. The bidding method capable of providing motivation for bidding in claim 1, wherein said bidding period can be modified.

4. The bidding method capable of providing motivation for bidding in claim 1, wherein said bidding party can be a single bidder or a group of bidders.

5. The bidding method capable of providing motivation for bidding in claim 1, wherein said first pre-determined rules generate said best bid according to said group of parameters.

6. The bidding method capable of providing motivation for bidding in claim 1, wherein said second pre-determined rules include a first rule to set said contract to be a binding contract, if said best bid is less than or equal to said bidding ceiling defined by said group of parameters, and a second rule to set said contract to be a conditional contract, if said best bid is higher than said bidding ceiling defined by said group of parameters, said conditional contract becoming a binding contract if said posting party accepting said best bid within a certain period of time defined by said second pre-determined rules, said second pre-determined rules preventing said bidding party from withdrawing said best bid within said certain period of time.

7. A bidding system capable of providing motivation for bidding, said bidding system comprising:
means for posting an item for bidding by a posting party;
means for establishing a bidding period by said posting party;
means for establishing a bidding ceiling by said posting party, said bidding ceiling having a group of parameters;
means for starting said bidding period;
means for gathering a bid from a bidding party within said bidding period;
means for processing said bid according to a first pre-determined rules to generate a best bid;
means for repeating above two steps within said bidding period;
means for ending said bidding period; and
means for establishing a contract for said item according to a second per-determined rules.

8. The bidding system capable of providing motivation for bidding in claim 7, wherein said item for bidding can be one single item, or a group of items.

9. The bidding system capable of providing motivation for bidding in claim 7, wherein said bidding period can be modified.

10. The bidding system capable of providing motivation for bidding in claim 7, wherein said bidding party can be a single bidder or a group of bidders.

11. The bidding system capable of providing motivation for bidding in claim 7, wherein said first pre-determined rules generate said best bid according to said group of parameters.

12. The bidding system capable of providing motivation for bidding in claim 7, wherein said second pre-determined rules include a first rule to set said contract to be a binding contract, if said best bid is less than or equal to said bidding ceiling defined by said group of parameters, and a second rule to set said contract to be a conditional contract, if said best bid is higher than said bidding ceiling defined by said group of parameters, said conditional contract becoming a binding contract if said posting party accepting said best bid within a certain period of time defined by said second pre-determined rules, said second pre-determined rules preventing said bidding party from withdrawing said best bid within said certain period of time.

13. A bidding computer program capable of providing motivation for bidding, said bidding computer program comprising:
computer program means for posting an item for bidding by a posting party;
computer program means for establishing a bidding period by said posting party;
computer program means for establishing a bidding ceiling by said posting party, said bidding ceiling having a group of parameters;
computer program means for starting said bidding period;
computer program means for gathering a bid from a bidding party within said bidding period;
computer program means for processing said bid according to a first pre-determined rules to generate a best bid;
computer program means for repeating above two steps within said bidding period;
computer program means for ending said bidding period; and
computer program means for establishing a contract for said item according to a second per-determined rules.

14. The bidding computer program capable of providing motivation for bidding in claim 13, wherein said item for bidding can be one single item, or a group of items.

15. The bidding computer program capable of providing motivation for bidding in claim 13, wherein said bidding period can be modified.

16. The bidding computer program capable of providing motivation for bidding in claim 13, wherein said bidding party can be a single bidder or a group of bidders.

17. The bidding computer program capable of providing motivation for bidding in claim 13, wherein said first pre-determined rules generate said best bid according to said group of parameters.

18. The bidding computer program capable of providing motivation for bidding in claim 13, wherein said second pre-determined rules include a first rule to set said contract to be a binding contract, if said best bid is less than or equal to said bidding ceiling defined by said group of parameters, and a second rule to set said contract to be a conditional contract, if said best bid is higher than said bidding ceiling defined by said group of parameters, said conditional contract becoming a binding contract if said posting party accepting said best bid within a certain period of time defined by said second pre-determined rules, said second pre-determined rules preventing said bidding party from withdrawing said best bid within said certain period of time.
